(19) United States
(12) Patent Application Publication
(10) Pub. No.: US 2025/0298776 A1
(43) Pub. Date: Sep. 25, 2025

(54) METHOD AND SYSTEM FOR AUTOMATICALLY CREATING FILE NAME

(71) Applicant: SAMSUNG SDS CO., LTD., Seoul (KR)

(72) Inventors: Ji Yeon LEE, Seoul (KR); Young Hyun CHOI, Seoul (KR); Seung Jin KIM, Seoul (KR)

(73) Assignee: SAMSUNG SDS CO., LTD., Seoul (KR)

(21) Appl. No.: 19/072,475

(22) Filed: Mar. 6, 2025

(30) Foreign Application Priority Data
Mar. 19, 2024 (KR) 10-2024-0037620
May 23, 2024 (KR) 10-2024-0067186

(51) Int. Cl. G06F 16/16; G06F 40/30

(52) U.S. Cl. CPC G06F 16/166; G06F 40/30

(57) ABSTRACT

An automatic file name creation method may include inputting a first file and a first prompt to a first artificial neural network, and creating a first semantic text corresponding to first semantic information of the first file based on an output of the first artificial neural network, receiving second setting information specifying a file name creation rule, creating a second prompt instructing to modify the first semantic text according to the file name creation rule based on the second setting information, inputting the first semantic text and the second prompt to a second artificial neural network, and creating a first file name associated with the first semantic text corresponding to the file name creation rule, based on an output of the second artificial neural network and changing the file name of the first file to the first file name.

### CROSS-REFERENCE TO RELATED APPLICATIONS

This application claims priority from Korean Patent Application Nos. 10-2024-0037620 filed on Mar. 19, 2024 and 10-2024-0067186 filed on May 23, 2024 in the Korean Intellectual Property Office, and all the benefits accruing therefrom under 35 U.S.C. 119, the contents of which in its entirety are herein incorporated by reference.

### BACKGROUND

### Field

The present disclosure relates to a method for automatically creating a file name and a system to which the method is applied. More specifically, the present disclosure relates to a method for automatically changing a file name based on contents of a file and a system to which the method is applied.

### Description of Related Art

When a worker has acquired a plurality of files for a business, the worker should create a file name based on the contents of the file and a formal rule for coping with a context in which another worker refers to the file and for the purpose of managing a version of the file.

Conventionally, as illustrated in FIG. 1, there is an inconvenience in that a worker has to directly read and check the contents of each of a plurality of files in a local file folder and manually write the file name of each of the plurality of files.

In managing the file name, there are many cases in which a worker related to a file as a file name change target is responsible for grasping the contents of the file. Thus, a time cost of managing the file name is excessive, such that the worker cannot request assistance from another worker. Accordingly, a loss of a company or organization occurs as much as a total amount of a time required for the workers to change the file name.

Therefore, in order to solve the loss of the time cost, a method of automatically creating a file name according to the contents of a file is conventionally required. However, there is a technical difficulty in creating a file name of each of a plurality of files in a formal manner according to a predetermined rule, and thus the above described scheme is not provided in the related art.

### SUMMARY

A technical purpose to be achieved in accordance with some embodiments of the present disclosure is to provide a method for automatically creating a file name corresponding to file contents extracted according to a feature specified by a user.

Another technical purpose to be achieved in accordance with some embodiments of the present disclosure is to provide a method for automatically creating a file name corresponding to a file name creation rule predefined by a user.

Still another technical purpose to be achieved in accordance with some embodiments of the present disclosure is to provide a method for creating a file name of a file uploaded by a user in a chatting session based on a conversation history of the chatting session.

Still yet another technical purpose to be achieved in accordance with some embodiments of the present disclosure is to provide a method for determining only a file corresponding to a feature specified by a user among a plurality of files as a file name change target.

The technical purposes of the present disclosure are not limited to the technical purposes mentioned above, and other technical purposes not mentioned may be clearly understood by those skilled in the art from the following description.

According to some embodiments of the present disclosure, an automatic file name creation method performed by a computing system is provided. The method may comprise acquiring a first file as a file name change target, receiving first setting information about one of semantic information represented by contents of the first file, creating a first prompt instructing to extract first semantic information from the first file based on the first setting information, inputting the first file and the first prompt to a first artificial neural network, and creating a first semantic text corresponding to the first semantic information of the first file based on an output of the first artificial neural network, receiving second setting information specifying a file name creation rule, creating a second prompt instructing to modify the first semantic text according to the file name creation rule based on the second setting information, inputting the first semantic text and the second prompt to a second artificial neural network, and creating a first file name associated with the first semantic text corresponding to the file name creation rule, based on an output of the second artificial neural network and changing a file name of the first file to the first file name. The first artificial neural network may be a large multi-modal model, the second artificial neural network may be a large language model.

In some embodiments, the method may further comprise identifying that a user uploads the first file in a first chatting session via a message application and inputting a context of the first chatting session and the first file to the first artificial neural network, and creating the first semantic text corresponding to the context of the first chatting session, based on the output of the first artificial neural network.

In some embodiments, the first file has an image format, the first semantic information may be information related to a first object included in an image of the first file. The creating of the first semantic text corresponding to the first semantic information may include inputting the first file and the first prompt to the first artificial neural network and creating the first semantic text associated with the first object, based on the output of the first artificial neural network.

In some embodiments, when the first file has a video format, the first semantic information may be information related to a motion of an object included in a video of the first file.

In some embodiments, when the first file has an audio format, the first semantic information may be information related to a script of an utterance included in an audio of the first file.

In some embodiments, the acquiring of the first file as the file name change target may include determining, as the file name change target, the first file corresponding to third setting information among an acquired plurality of files, based on the third setting information input by a user.

In some embodiments, the determining of the first file corresponding to the third setting information among the acquired plurality of files as the file name change target, based on the third setting information input by the user may include determining, as the file name change target, the first file including a first object specified by the third setting information among an acquired plurality of image format files.

In some embodiments, the determining of the first file corresponding to the third setting information among the acquired plurality of files as the file name change target, based on the third setting information input by the user may include determining, as the file name change target, the first file including an object performing a first motion specified by the third setting information among an acquired plurality of video format files.

In some embodiments, the determining of the first file corresponding to the third setting information among the acquired plurality of files as the file name change target, based on the third setting information input by the user may include determining, as the file name change target, the first file including utterance of a first speaker specified by the third setting information among an acquired plurality of audio format files.

In some embodiments, the second prompt may be determined based on a file name format of a file having a history in which a user has manually changed a file name, the file having the history in which the user has manually changed the file name is a file having a similarity to the first file greater than or equal to a reference value.

In some embodiments, The method may further comprise receiving, from a user, a request to store the first file being created by the user, storing the first file using a temporary file name and displaying information about a time required to create the file name of the first file on a screen.

According to some embodiments of the present disclosure, an automatic file name creation system is provided. The system may comprise one or more processors and a memory storing therein a computer program executed by the one or more processors. The computer program may include instructions for acquiring a first file as a file name change target, receiving first setting information about one of semantic information represented by contents of the first file, creating a first prompt instructing to extract first semantic information from the first file based on the first setting information, inputting the first file and the first prompt to a first artificial neural network, and creating a first semantic text corresponding to the first semantic information of the first file based on an output of the first artificial neural network, receiving second setting information specifying a file name creation rule, creating a second prompt instructing to modify the first semantic text according to the file name creation rule based on the second setting information, inputting the first semantic text and the second prompt to a second artificial neural network, and creating a first file name associated with the first semantic text corresponding to the file name creation rule, based on an output of the second artificial neural network and changing a file name of the first file to the first file name. The first artificial neural network may be a large multi-modal model, the second artificial neural network may be a large language model.

In some embodiments, when the first file has an image format, the first semantic information may be information related to a first object included in an image of the first file. The creating of the first semantic text corresponding to the first semantic information may include inputting the first file and the first prompt to the first artificial neural network and creating the first semantic text associated with the first object, based on the output of the first artificial neural network.

In some embodiments, when the first file has a video format, the first semantic information may be information related to a motion of an object included in a video of the first file.

In some embodiments, when the first file has an audio format, the first semantic information may be information related to a script of an utterance included in an audio of the first file.

In some embodiments, the acquiring of the first file as the file name change target may include determining, as the file name change target, the first file corresponding to third setting information among an acquired plurality of files, based on the third setting information input by a user.

In some embodiments, the determining of the first file corresponding to the third setting information among the acquired plurality of files as the file name change target, based on the third setting information input by the user may include determining, as the file name change target, the first file including a first object specified by the third setting information among an acquired plurality of image format files.

In some embodiments, the determining of the first file corresponding to the third setting information among the acquired plurality of files as the file name change target, based on the third setting information input by the user may include determining, as the file name change target, the first file including an object performing a first motion specified by the third setting information among an acquired plurality of video format files.

In some embodiments, the determining of the first file corresponding to the third setting information among the acquired plurality of files as the file name change target, based on the third setting information input by the user may include determining, as the file name change target, the first file including utterance of a first speaker specified by the third setting information among an acquired plurality of audio format files.

In some embodiments, the computer program may further include instructions for identifying that a user uploads the first file in a first chatting session via a message application and inputting a context of the first chatting session and the first file to the first artificial neural network, and creating the first semantic text corresponding to the context of the first chatting session, based on the output of the first artificial neural network.

Specific details of other embodiments are included in the detailed description and drawings.

### BRIEF DESCRIPTION OF DRAWINGS

The above and other aspects and features of the present disclosure will become more apparent by describing in detail embodiments thereof with reference to the attached drawings, in which:

FIG. 1 is an example diagram for illustrating a technical problem of a conventional method for changing a file name;

FIG. 2 illustrates an example environment to which an automatic file name creation system according to an embodiment of the present disclosure may be applied;

FIG. 3 is an example block diagram of a system for automatically creating a file name according to another embodiment of the present disclosure;

FIG. 4 is an example diagram for illustrating an operation of a semantic analysis unit according to some embodiments of the present disclosure;

FIG. 5 is an example diagram for illustrating an operation of a file name creating unit according to some embodiments of the present disclosure;

FIG. 6 is a flowchart of a method for automatically creating a file name according to still another embodiment of the present disclosure;

FIG. 7 is an example diagram for illustrating a step of acquiring a first file as a file name change target, which may be performed in some embodiments of the present disclosure;

FIG. 8 is an example diagram for illustrating a step of acquiring a first file as a file name change target, which may be performed in some embodiments of the present disclosure;

FIG. 9 is an example diagram for illustrating a step of receiving first setting information, that may be performed in some embodiments of the present disclosure;

FIG. 10 is an example diagram for illustrating a step of creating a first semantic text based on a first prompt and an output of a first artificial neural network, which may be performed in some embodiments of the present disclosure;

FIG. 11 is an example diagram for illustrating a step of creating a first semantic text based on a first prompt and an output of a first artificial neural network, which may be performed in some embodiments of the present disclosure;

FIG. 12 is an example diagram for illustrating a step of creating a first semantic text based on a first prompt and an output of a first artificial neural network, which may be performed in some embodiments of the present disclosure;

FIG. 13 is an example diagram for illustrating a step of receiving second setting information, that may be performed in some embodiments of the present disclosure;

FIG. 14 is an example diagram for illustrating a step of creating a first file name based on a second prompt and an output of a second artificial neural network, which may be performed in some embodiments of the present disclosure;

FIG. 15 is a diagram illustrating an example of creating a first file name based on context information of a chatting session, that may be performed in some embodiments of the present disclosure; and

FIG. 16 is an example diagram for illustrating a step of determining a first file name based on a file name of a file having a history in which the user has manually changed the file name, which may be performed in some embodiments of the present disclosure; and

FIG. 17 is a hardware configuration diagram of a computing system according to still another embodiment of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Prior to the description of various embodiments of the present disclosure, terms used in embodiments as set forth below will be clearly described.

In embodiments as set forth below, ‘semantic information’ may refer to information represented by contents of a specific file.

For example, the semantic information may include contents of a text visually represented by a specific image file.

In another example, the semantic information may include information related to a motion of an object included in a specific image file or a specific video file.

In still another example, the semantic information may include name information of an object included in a specific image file.

In still yet another example, the semantic information may include a summary result of a specific text file.

In still yet another example, the semantic information may include feature information of an object included in a specific image file. For example, the semantic information may include color information of clothes worn by a specific person photographed in a specific image.

In still yet another example, the semantic information may include information about contents uttered by a specific speaker of a specific audio file.

In still yet another example, the semantic information may include information about contents uttered by a specific person included in a specific video file.

In still yet another example, the semantic information may include information on a document topic of a specific document format file.

In still yet another example, the semantic information may include appearance frequency information of a subject photographed in a specific video file. For example, the semantic information may include information on a time when a first subject appears in a video and a time when a second subject appears in the video.

In still yet another example, the semantic information may include utterance time information of each of a plurality of speakers included in a specific audio file.

Referring to the above some examples, the semantic information according to some embodiments of the present disclosure means contents included in a specific file that may be represented in natural language. Thus, it may be understood that the semantic information is interpreted as not limiting. In addition, in embodiments as set forth below, ‘semantic text’ may refer to a text representing the semantic information in natural language.

Hereinafter, some embodiments of the present disclosure will be described with reference to the drawings.

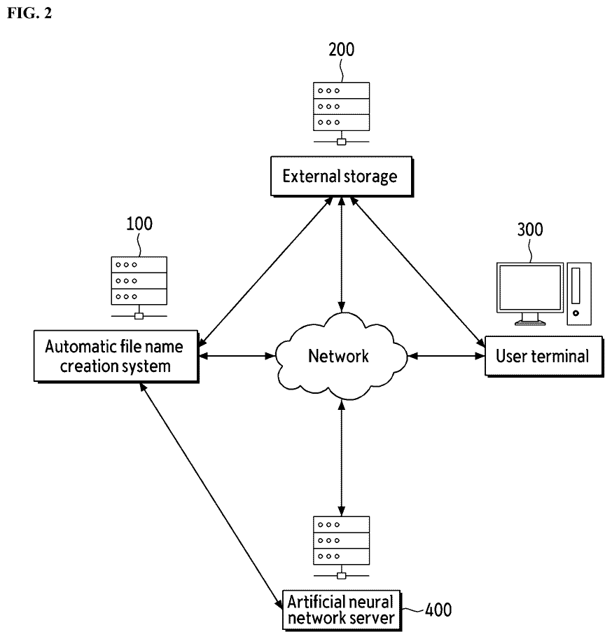

FIG. 2 illustrates an example environment to which an automatic file name creation system according to an embodiment of the present disclosure may be applied.

Each of components illustrated in FIG. 2 may refer to software or hardware such as a field programmable gate array (FPGA) or an application-specific integrated circuit (ASIC). However, each of the components is not limited to software or hardware, and may be configured to be present in an addressable storage medium, or may be configured to execute one or more processors. A function provided in each of the components may be implemented by more subdivided components. Alternatively, a plurality of components may be combined with each other into one component that performs a specific function.

In some embodiments, an automatic file name creation system 100 may communicate with other components via a network. The network may be embodied as wired/wireless networks of all kinds, such as a Local Area Network (LAN), a Wide Area Network (WAN), a mobile radio communication network, and a wireless broadband Internet (WiBro).

An user terminal 300 may be a laptop, a desktop, a laptop, a smartphone, a tablet, or the like. However, the present disclosure is not limited thereto, and the user terminal 300 may include all types of devices equipped with a computing function.

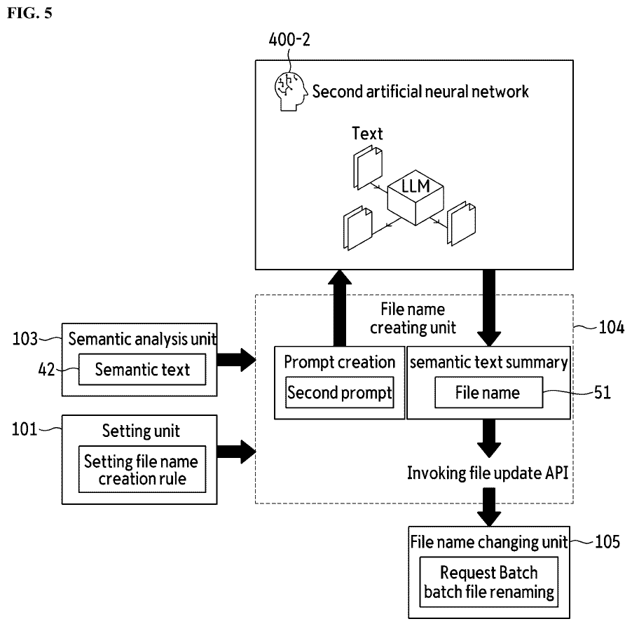

Hereinafter, an operation that may be performed by each of the components illustrated in FIG. 2 will be described with reference to FIGS. 2 to 5.

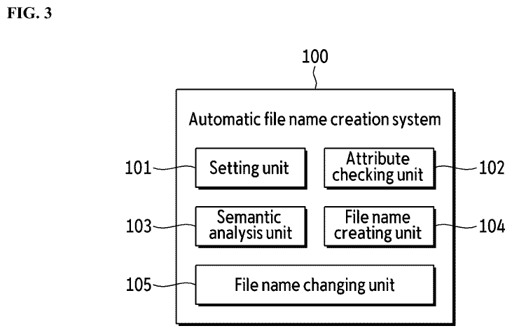

Referring to FIG. 3, the system 100 for automatically creating a file name according to an embodiment of the present disclosure may include a setting unit 101, an attribute checking unit 102, a semantic analysis unit 103, a file name creating unit 104, and a file name changing unit 105.

The setting unit 101 of the automatic file name creation system 100 according to an embodiment of the present disclosure may acquire a first file as a file name change target.

In some embodiments of the present disclosure, the attribute checking unit 102 may determine that a format of the acquired first file is one of an image, video, text, document, and audio.

In some further embodiments of the present disclosure, when it is identified that the user terminal 300 uploads the first file to external storage 200, the setting unit 101 of the automatic file name creation system 100 may determine the first file as the file name change target.

In some further embodiments of the present disclosure, the setting unit 101 of the automatic file name creation system 100 may determine each of the plurality of files as the file name change target, based on a determination that a size of each of the plurality of files uploaded by the user terminal 300 to the external storage 200 is greater than or equal to a threshold.

In some still further embodiments of the present disclosure, the setting unit 101 of the automatic file name creation system 100 may determine each of the plurality of files as the file name change target, based on a determination that the number of the plurality of files uploaded by the user terminal 300 to the external storage 200 is greater than or equal to a threshold.

In some still yet further embodiments of the present disclosure, the setting unit 101 of the automatic file name creation system 100 may determine only a file corresponding to third setting information among the acquired plurality of files as the file name change target, based on the third setting information input by the user. This will be described later.

The setting unit 101 of the automatic file name creation system 100 according to another embodiment of the present disclosure may receive first setting information on one of the semantic information represented by the contents of a specific file from the user.

In some embodiments of the present disclosure, for example, the setting unit 101 of the automatic file name creation system 100 may receive, from a user, a query “extract information on a motion performed by Kim Cheol-Soo from an image,” input the query to a large language model (LLM), and determine, as the first setting information, extracting of information on the motion performed by Kim Cheol-Soo from a file as a file name change target, based on an output of the LLM.

The semantic analysis unit 103 of the automatic file name creation system 100 according to another embodiment of the present disclosure may create a first prompt based on the first setting information.

In some embodiments of the present disclosure, the first prompt may be created to be input to the first artificial neural network, or may be a prompt instructing to extract first semantic information from a specific file based on the first setting information.

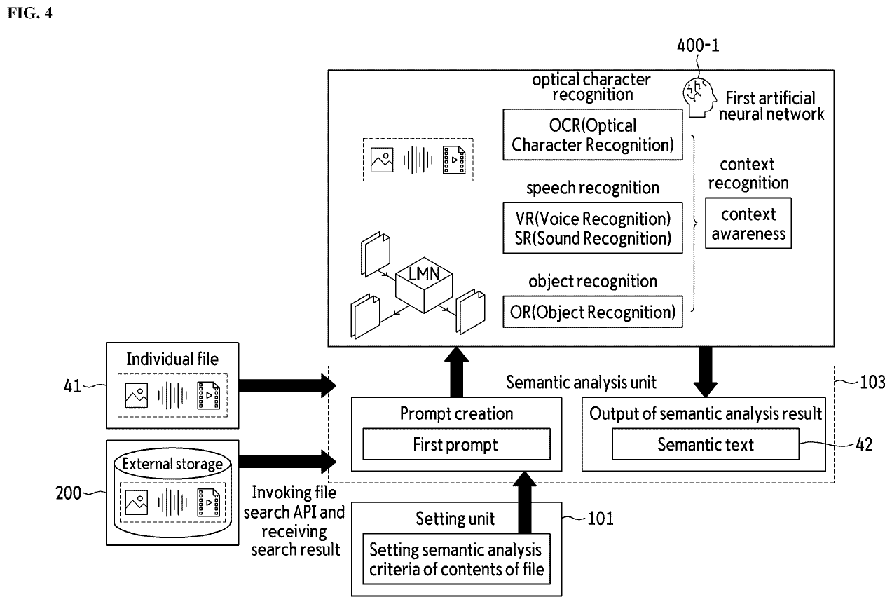

In some further embodiments of the disclosure, referring to FIG. 4, the semantic analysis unit 103 may receive a specific file 41 from a user or may receive at least a portion of a file pre-stored in the external storage 200 from the external storage 200.

In some still further embodiments of the disclosure, referring to FIG. 4, the semantic analysis unit 103 may transmit the acquired file and the first prompt to the artificial neural network server 400 to input the acquired file and the first prompt to a first artificial neural network 400-1, and create a semantic text 42 corresponding to the first semantic information of the acquired file, based on an output of the first artificial neural network 400-1. In this regard, the first artificial neural network 400-1 may mean a LMM (Large multi-modal Model).

In this regard, the large multi-modal model may be a conventional artificial neural network model that receives a plurality of types of data and learns and processes relationships between the plurality of types of data, such as Gemini, Generative Pre-Trained Transformer (GPT) Vision, and Gauss, and is not limited to one thereof.

For example, in the present embodiment, when the first semantic information is ‘information on the motion performed by Kim Cheol-Soo’ in the acquired file, the semantic text 42 may be output as ‘Kim Cheol-Soo is cutting a cake.

In some still further embodiments of the present disclosure, when the acquired file is a text format file, the first artificial neural network 400-1 may perform optical character recognition (OCR) on the file, create the semantic text 42 based on a result of performing semantic analysis on a text acquired according to a result of the OCR, and transmit the semantic text to the semantic analysis unit 103.

In some still further embodiments of the present disclosure, when the acquired file is a file in an audio format, the first artificial neural network 400-1 may perform voice recognition (VR) and sound recognition (SR) on the file, and may create the semantic text 42 based on a result of performing semantic analysis on a text acquired according to results of the VR and SR, and transmit the created semantic text to the semantic analysis unit 103.

In some further embodiments of the present disclosure, when the acquired file is a file of an image or video format, the first artificial neural network 400-1 may perform object recognition (OR) on the file, create semantic text 42 based on a result of performing semantic analysis on a text acquired according to a result of the OR, and transmit the semantic text 42 to the semantic analysis unit 103.

The setting unit 101 of the automatic file name creation system 100 according to still another embodiment of the present disclosure may receive second setting information specifying a file name creation rule. This will be described in detail later.

The file name creation unit 104 of the automatic file name creation system 100 according to still another embodiment of the present disclosure may receive the second setting information specifying the file name creation rule from the setting unit 101, receive the semantic text 42 corresponding to the first semantic information from the semantic analysis unit 103, and create a second prompt based on the received semantic text 42 and the received second setting information.

In some embodiments of the present disclosure, the file name creation unit 104 may transmit the second prompt to the artificial neural network server 400 corresponding to a second artificial neural network 400-2, and may create a file name 51 associated with the semantic text 42 corresponding to the rule for creating the file name, based on the output of the second artificial neural network 400-2.

In some further embodiments of the present disclosure, the second artificial neural network 400-2 may refer to a conventional large language model. In this regard, the large language model may include a conventional language model such as GPT, Phi, BERT, Gemini, and the like. However, as long as the large language model has a parameter size greater than or equal to a reference value, it is not limited to one thereof.

The file name changing unit 105 of the automatic file name creation system 100 according to still another embodiment of the present disclosure may receive the file name 51 from the file name creating unit 104 and change a name of the acquired file to the file name 51.

The components included in an example environment to which the automatic file name creation system 100 may be applied, and operations that the components may perform have been described with reference to FIGS. 2 to 5. It may be understood that the automatic file name creation system 100 and the user terminal 300 operate according to a server-client model. However, in some embodiments, the system may be configured in a client stand-alone manner without the need for a server. In this case, it may be understood that the operation performed by the automatic file name creation system 100 is performed by the user terminal 300.

It should be understood that the embodiments described above are merely examples and non-limiting in all aspects. In addition, the configuration and operation of the automatic file name creation system 100 according to the present embodiment may be supplemented based on some embodiments described below.

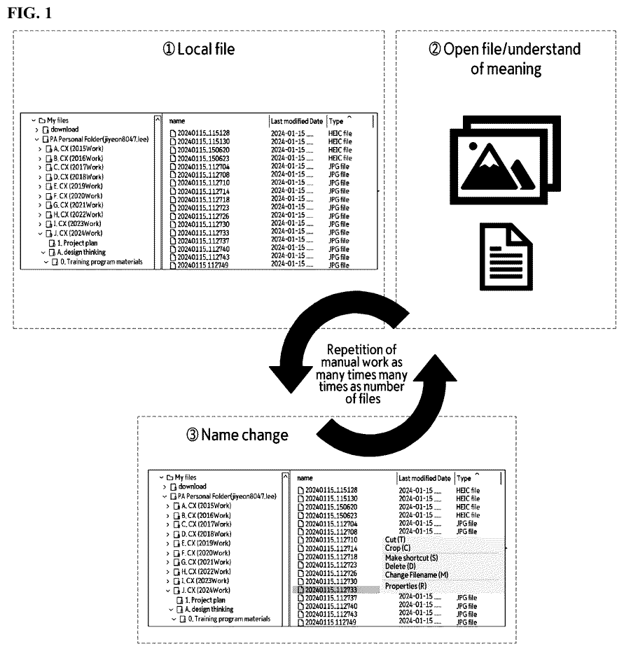

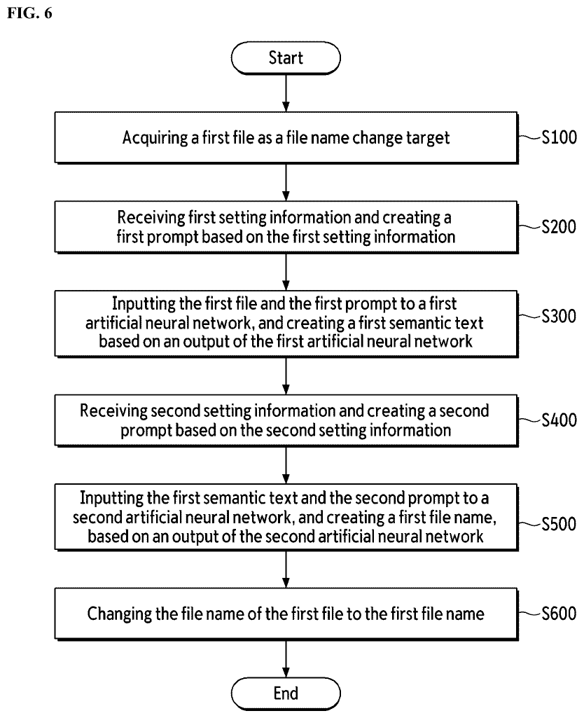

Hereinafter, a method for automatically creating a file name according to still another embodiment of the present disclosure will be described with reference to FIGS. 6 to 16. Steps to be described below with reference to some flowcharts may be understood to be performed by the automatic file name creation system 100 as described with reference to FIG. 1 unless otherwise stated. In addition, it is obvious that the technical idea that may be understood in the embodiment above-described with reference to FIG. 1 may be applied to the method for automatically creating a file name.

In step S100, the system 100 for automatically creating a file name may acquire a first file as a file name change target.

Hereinafter, in describing some embodiments of the present disclosure, in order to help understanding of the present disclosure, a character string input by a user may be defined as a query, and a character string created by a specific system may be defined as a prompt.

In some embodiments related to step S100, the system 100 for automatically creating a file name may acquire a first file input by a user and determine the first file as a file name change target.

In some further embodiments related to step S100, the automatic file name creation system 100 may determine the first file corresponding to third setting information among the acquired plurality of files as the file name change target, based on the third setting information input by the user.

In some further embodiments related to step S100, the automatic file name creation system 100 may determine the first file including a first object specified by the third setting information among the acquired plurality of files in the image format as the file name change target. This embodiment may be clearly understood with reference to an embodiment in which a plurality of video files are acquired as described later.

In some still further embodiments related to step S100, the automatic file name creation system 100 may determine the first file including context information specified by the third setting information among the acquired plurality of files in the video format or the image format as the file name change target.

For example, the automatic file name creation system 100 may perform a semantic analysis on each of the acquired plurality of video format or image format files, based on the determination that the third setting information indicates a conference context, and may determine an image file or a video file identified as having the conference context based on a result of performing the semantic analysis as the file name change target.

In some still further embodiments related to step S100, the system 100 for automatically creating a file name may determine the first file among the acquired plurality of video format files in which an object specified by the third setting information appears for a reference time duration or longer as the file name change target.

For example, the automatic file name creation system 100 may acquire instruction information of selecting the ‘image in which Kim Cheol-Soo has appeared the most frequently’ from the query of the third setting information received from the user terminal 300, and may determine the first file among the acquired plurality of video format files in which an appearance frequency of an object identified as Kim Cheol-Soo is greater than an appearance frequency of another object as the file name change target.

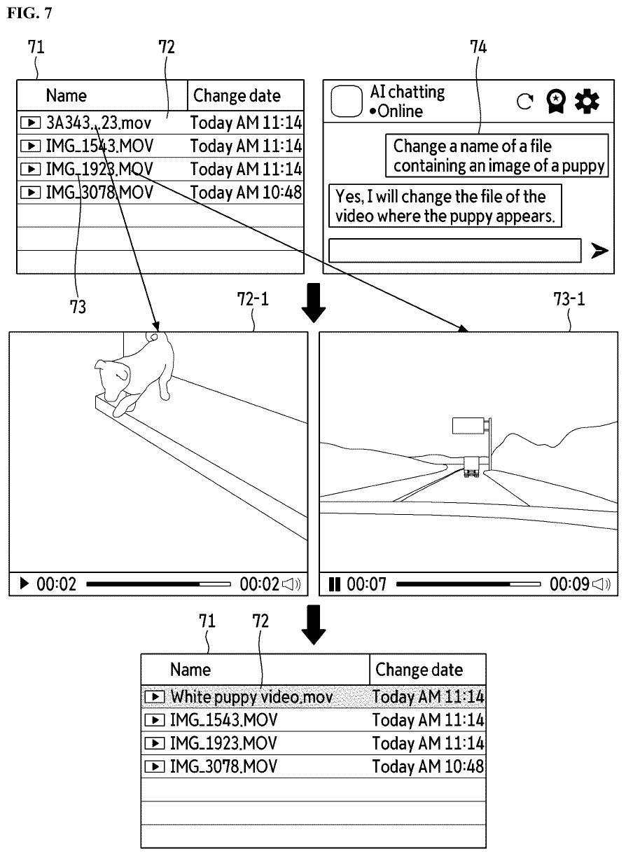

In some still further embodiments related to step S100, referring to FIG. 7, the automatic file name creation system 100 may acquire a first video set 71 via a user input to the user terminal 300, receive a first query 74 of the third setting information from the user terminal 300, and determine a first video 72 corresponding to setting information of the first query 74 of the third setting information among video files of the first video set 71 as the file name change target, based on a semantic analysis result of the first query 74 of the third setting information.

In some still further embodiments related to step S100, referring to FIG. 7, upon determination that the third setting information means ‘a video including a white puppy object’ based on the semantic analysis result of the first query 74 of the third setting information, the automatic file name creation system 100 may determine a second video 73 including a road object 73-1 in the first video set 71 as a file not subjected to the file name change and may determine the first video 72 including a white puppy object 72-1 as a file subjected to the file name change, that is, the file name change target.

In the above-described embodiment, an example in which the third setting information is acquired based on a result of semantic analysis of the first query 74 of the third setting information received from the user terminal 300 has been described above. However, in some still further embodiments related to step S100, the third setting information may be one of a plurality of predefined setting information selected by the user through the user interface.

In some still further embodiments related to step S100, the automatic file name creation system 100 may determine the first file including the utterance of the first speaker specified by the third setting information among the acquired plurality of files in the audio format as the file name change target.

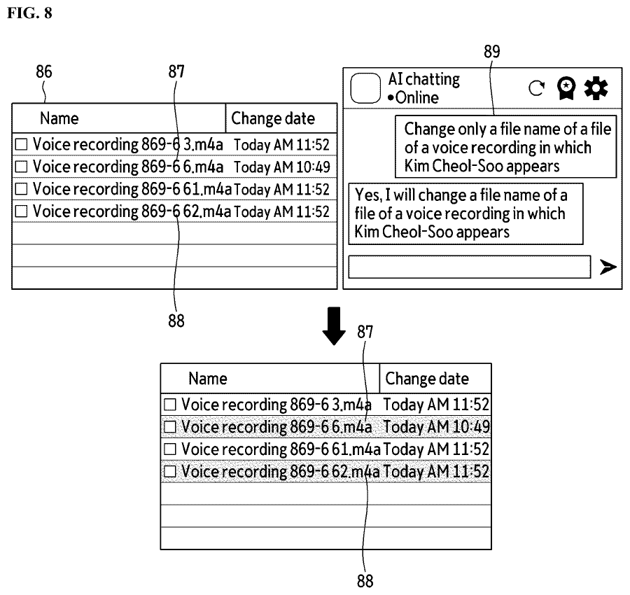

In some further embodiments related to step S100, referring to FIG. 8, the automatic file name creation system 100 may acquire a first audio set 86 via a user input to the user terminal 300, receive a second query 89 of the third setting information from the user terminal 300, and determine a first audio file 87 and a second audio file 88 corresponding to the setting information of the second query 89 of the third setting information among the audio files of the first audio set 86 as the file name change target, based on the semantic analysis result of the second query 89 of the third setting information.

In some further embodiments related to step S100, referring to FIG. 8, the automatic file name creation system 100 may determine the first audio file 87 and the second audio file 88 including the utterance of Kim Cheol-Soo as the file name change target, based on a determination that the third setting information means ‘audio including the speaker of Kim Cheol-Soo’ based on a result of semantic analysis of the second query 89 of the third setting information.

In some still further embodiments related to step S100, the automatic file name creation system 100 may determine an audio file having an utterance time of Kim Cheol-Soo' greater than that of each of other utterers or speakers as a file name change target, based on a determination that the third setting information means ‘the audio in which the utterance time of Kim Cheol-Soo is the greatest’ based on a result of semantic analysis of the query of the third setting information.

In some still further embodiments related to step S100, the automatic file name creation system 100 may determine the first file including semantic information specified by the first setting information among the acquired plurality of document format or text format files as the file name change target.

For example, the semantic information specified by the first setting information may include a category of a document or text format file. In this regard, the category may include categories of a document or text format that may be identified using conventional semantic analysis methodologies such as meeting minutes, interviews, articles, proposals, and the like, and is not limited to one thereof.

In still another example, the semantic information specified by the first setting information may include specific information included in a document format or a text format file. For example, when the user sets the first setting information to changing of the file name of the file including the information related to a specific project, the system 100 for automatically creating the file name may determine only a file including the information related to the specific project among the acquired plurality of files in the text format or the document format as the file name change target.

In some still further embodiments related to step S100, the automatic file name creation system 100 may monitor a file uploaded by the user terminal 300 to the external storage 200. When the user terminal 300 uploads the number of files greater than or equal to a threshold to the external storage 200, the system 100 for automatically creating the file name may determine the file uploaded by the user terminal 300 to the external storage 200 as the file name change target.

In some still further embodiments related to step S100, the system 100 for automatically creating a file name may determine a file of an image format or a video format corresponding to a predefined context among the files uploaded by the user terminal 300 to the external storage 200 as a file name change target.

For example, the automatic file name creation system 100 may perform semantic analysis on files of a plurality of image formats uploaded by the user terminal 300 to the external storage 200, and determine an image file identified as having a conference context among the plurality of files in the image format based on a result of performing the semantic analysis as the file name change target.

In some still further embodiments related to step S100, the system 100 for automatically creating a file name may learn a file selection criterion based on which the file is selected as the file name change target by the user.

For example, the system 100 for automatically creating a file name may determine an image file identified as having a conference context among the acquired plurality of files as the file name change target, based on a determination that the number of times the user selects an image identified as having a conference context as the file name change target is greater than or equal to a reference value.

In another example, based on a determination that the number of times the user selects a file including specific semantic information as the file name change target is greater than or equal to a reference value, the system 100 for automatically creating a file name may automatically determine the file as the file name change target when the file corresponding to the semantic information is acquired.

In the above embodiments, it may be understood that the automatic file name creation system 100 performs semantic analysis on a specific file. However, in some still further embodiments of the present disclosure, the semantic analysis on the specific file may be performed by the artificial neural network server 400 to which the automatic file name creation system 100 has transmitted the specific file.

In step S200, the system 100 for automatically creating a file name may receive first setting information about one of semantic information represented by the contents of the first file from the user terminal 300, and create a first prompt instructing to extract first semantic information from the first file based on the first setting information.

In some embodiments related to step S200, an example in which the first setting information is acquired based on a semantic analysis result of a query of the first setting information created by the user as received from the user terminal 300 may be set forth. However, in some further embodiments related to step S200, the first setting information may mean one of a plurality of predefined setting information selected by the user through the user interface.

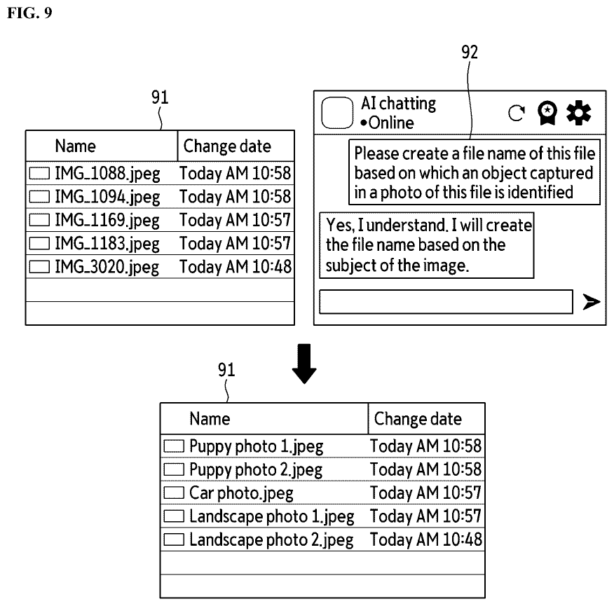

In some still further embodiments related to step S200, referring to FIG. 9, the automatic file name creation system 100 may extract information associated with a subject name of the image according to the first query 92 of the first setting information received from the user terminal 300 and create the file name of each of the images included in the first image set 91 based on the extracting result.

In some still further embodiments related to step S200, when the query of the first setting information received from the user terminal 300 means extracting the context of the image, the automatic file name creation system 100 may create a first prompt instructing to extract the context information of the acquired first image file. In some embodiments of the present disclosure, the present embodiment may be equally applied to a video file.

In some still further embodiments related to step S200, when the query of the first setting information received from the user terminal 300 means extracting semantic information related to a specific motion from the video format file, the automatic file name creation system 100 may create a first prompt instructing to extract information related to the motion of the object appearing in the acquired first video file. In some embodiments of the present disclosure, the present embodiment may be equally applied to an image file.

In some still further embodiments related to step S200, when the query of the first setting information received from the user terminal 300 means extracting semantic information related to an appearance time of each of the objects included in the video format file, the automatic file name creation system 100 may create a first prompt instructing to extract information related to the appearance time of each of the objects appearing in the acquired first video file.

In some still further embodiments related to step S200, when the query of the first setting information received from the user terminal 300 means extracting semantic information related to the utterance contents of each of the utterers or speakers included in the audio format file, the automatic file name creation system 100 may create a first prompt instructing to extract summary information about the utterance of each of the plurality of utterers or speakers included in the acquired first audio file.

In some still further embodiments related to step S200, when the query of the first setting information received from the user terminal 300 means extracting semantic information related to the utterance contents of a main speaker included in the audio format file, the automatic file name creation system 100 may create a first prompt instructing to extract summary information about the utterance of a specific speaker having the most utterance time from the acquired first audio file.

In some still further embodiments related to step S200, when the query of the first setting information received from the user terminal 300 means extracting semantic information related to information included in the document format or the text format file, the automatic file name creation system 100 may create a first prompt instructing to extract summary information on the contents of the acquired first text file or first document file.

Next, in step S300, the automatic file name creation system 100 may input the acquired first file and the first prompt to the first artificial neural network, and create a first semantic text corresponding to the first semantic information of the first file based on the output of the first artificial neural network.

In some embodiments related to step S300, the first semantic text may refer to text acquired based on a result of converting the semantic information described in the above embodiments into a natural language text.

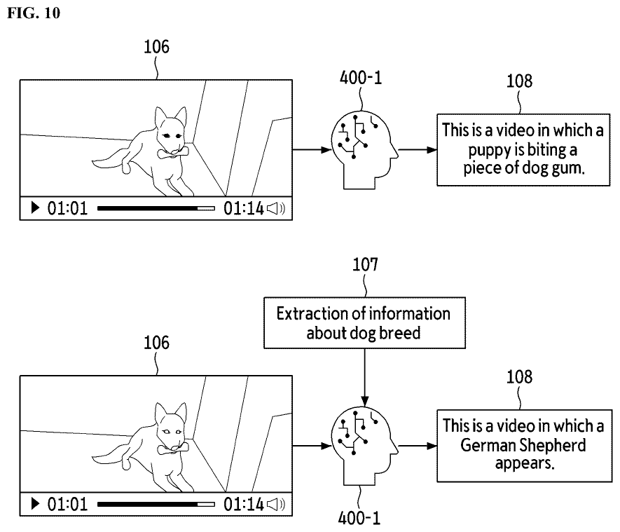

In some embodiments related to step S300, referring to FIG. 10, when only a first video file 106 is input to the first artificial neural network 400-1, the automatic file name creation system 100 may acquire a first semantic text 108 of ‘This is the video in which the puppy is biting a dog gum’. However, when the first prompt related to the first setting information 107 instructing to extract information on a dog breed set by the user in step S200 and the first video file 106 are input together to the first artificial neural network 400-1, the automatic file name creation system 100 may acquire the first semantic text 108 including information related to the dog breed.

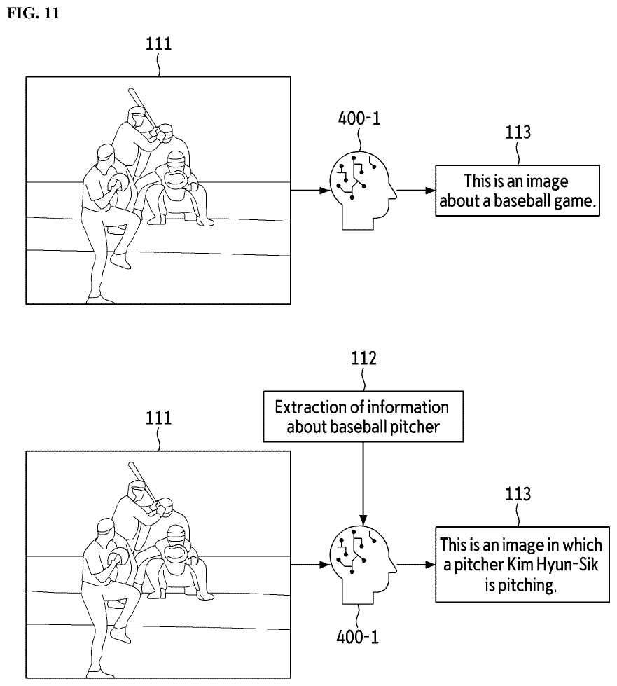

In some further embodiments related to step S300, referring to FIG. 11, when only a first image file 111 is input to the first artificial neural network 400-1, the automatic file name creation system 100 may acquire a second semantic text 113 of ‘This is an image related to a baseball game.’. However, when the first prompt related to the first setting information 112 indicating extraction of information on a pitcher set by the user in step S200 and the first image file 111 are input together to the first artificial neural network 400-1, the automatic file name creation system may acquire a second semantic text 113 including player information.

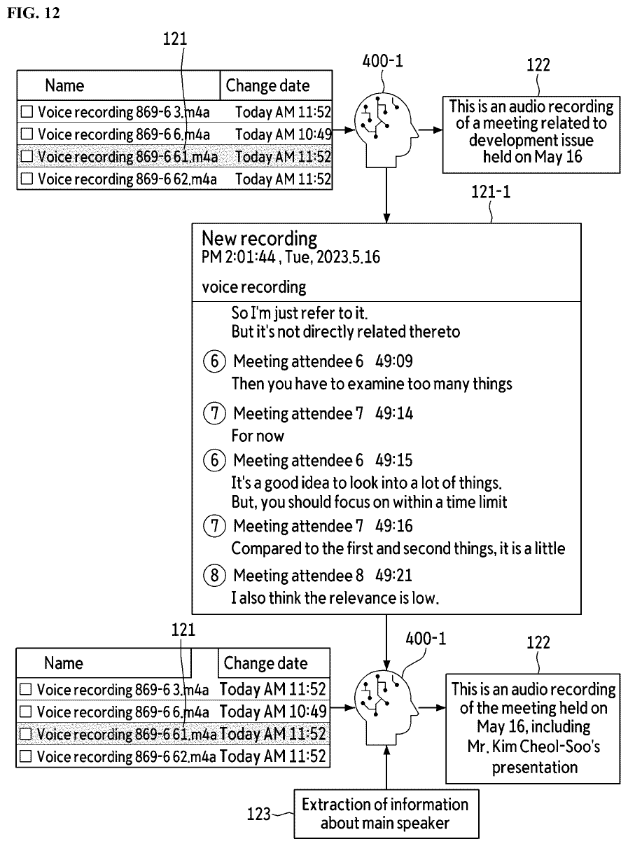

In some still further embodiments related to step S300, referring to FIG. 12, when only a first audio file 121 is input to the first artificial neural network 400-1, the automatic file name creation system 100 may acquire a third semantic text 122 of ‘This is a voice recording of a development issue-related meeting held on May 16’ as output based on a result obtained by performing speech to text (STT) on the first audio file 121 by the first artificial neural network 400-1. However, when a first prompt related to first setting information 133 instructing to extract information on a main speaker set by the user in step S200 and the first audio file 121 are input together into the first artificial neural network 400-1, the automatic file name creation system may acquire a third semantic text 122 including information on the main speaker of the audio file.

Next, in step S400, the automatic file name creation system 100 may receive second setting information specifying a file name creation rule, and create a second prompt according to the file name creation rule based on the second setting information.

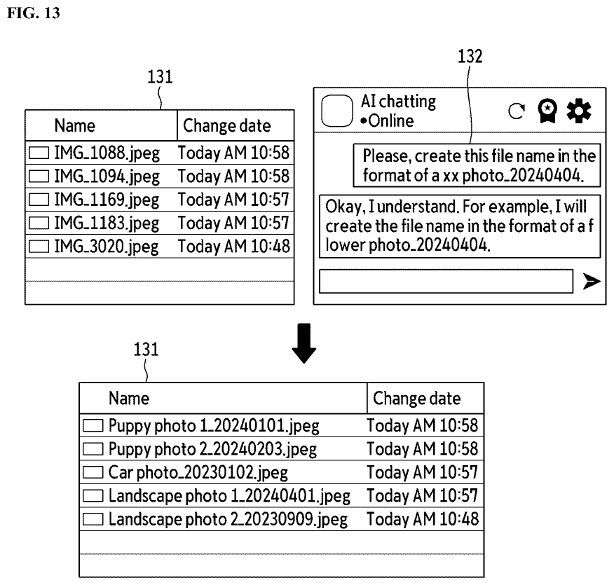

In some embodiments related to step S400, referring to FIG. 13, upon receiving second setting information 142 instructing to create a file name including a file creation date and information on a subject type of the image file, the automatic file name creation system 100 may create a second prompt corresponding to the second setting information 142 instructing to create the file name including the file creation date and the information on the subject type of the image file, and may change a file name of each of images of a second image set 131 as the file name change target based on the second prompt.

In the present embodiment, an example in which the second setting information is acquired based on a semantic analysis result of a query of the second setting information created by the user as received from the user terminal 300 may be set forth. However, in some further embodiments related to step S400, the second setting information may mean one of a plurality of predefined setting information selected by the user through the user interface.

In some further embodiments related to step S400, the second prompt may be determined based on a file name format of a file having a history in which the user has manually changed the file name. This will be described later.

In some still further embodiments related to step S400, when the semantic information of the acquired first file corresponds to the first industry, the automatic file name creation system 100 may create the second prompt based on a first file name creation rule predefined to correspond to the first industry.

In step S500, the automatic file name creation system 100 may input the first semantic text acquired in step S300 and the second prompt created in step S400 to the second artificial neural network, and may create a first file name associated with the first semantic text corresponding to the file name creation rule, based on the output of the second artificial neural network.

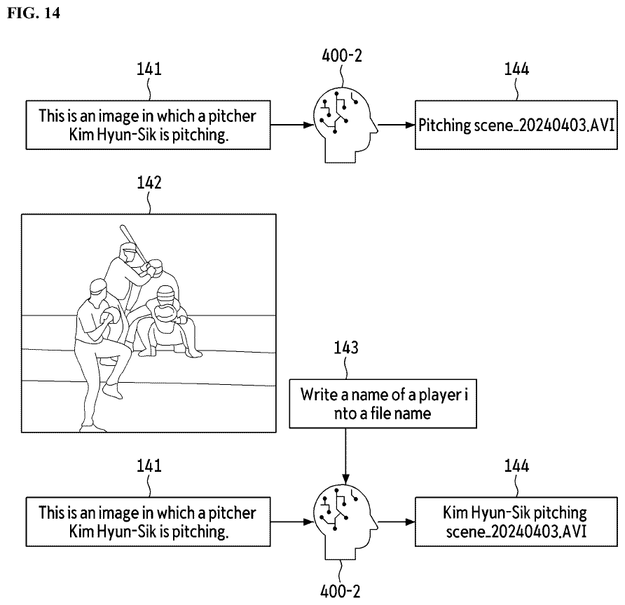

In some embodiments related to step S500, referring to FIG. 14, when a fourth semantic text 141 related to a second image file 132 and a second prompt including only an instruction to create the file name are input to the second artificial neural network 400-2, the automatic file name creation system 100 may acquire the first file name 144 related to the context of the second image file 132. However, when the second prompt created based on the second setting information 143 instructing to include the player's name and the fourth semantic text 141 are input to the second artificial neural network 400-2, the automatic file name creation system 100 may acquire the first file name 144 including the player name.

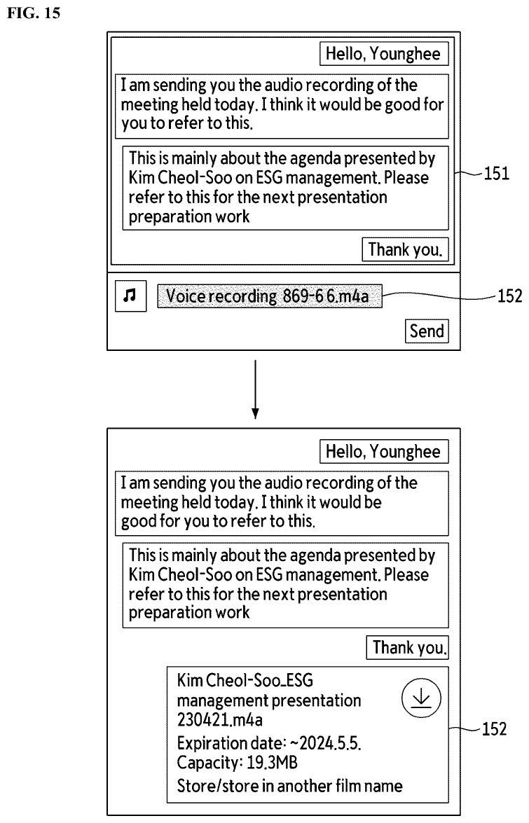

In some further embodiments related to step S500, referring to FIG. 15, the system 100 for automatically creating a file name may monitor whether a file is uploaded in a first chatting session 151 of a message application executed in the user terminal 300.

In addition, when it is identified that the user uploads the first file 152 in the first chatting session 151, the automatic file name creation system 100 may input the text of the first chatting session 151 to the first artificial neural network, may acquire semantic text related to the context of the first chatting session 151 from the first artificial neural network, may input the semantic text related to the context of the first chatting session 151 to the second artificial neural network, and may automatically change the file name of the first file 152 uploaded in the first chatting session 151 based on the output of the second artificial neural network.

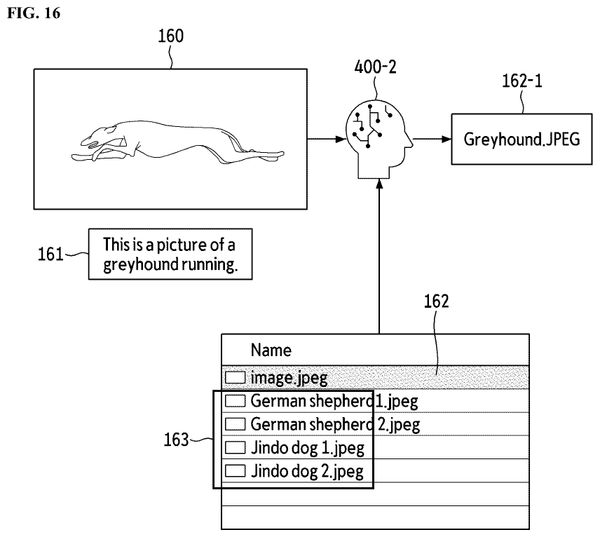

In some still further embodiments related to step S500, referring to FIG. 16, the automatic file name creation system 100 may create a second prompt instructing to include a dog name in a file name based on a file name creation rule of each of images of a third image set 163 having a history in which a user manually changed the file name, input the second prompt and a fifth semantic text 161 related to an image 160 of a third image file to the second artificial neural network 400-2, and acquire a third file name 162-1 of a third file 162 based on an output of the second artificial neural network 400-2.

In some still further embodiments related to step S500, the system 100 for automatically creating a file name may automatically change and store the file name of the first file being created by the user using the user terminal 300, based on the contents of the first file.

For example, the user may input a request of storing a first file being created by the user using the user terminal 300 into the user terminal 300 to the user terminal 300. In this case, the automatic file name creation system 100 may receive the request of storing the first file from the user terminal 300, the user terminal 300 may store the first file using a temporary file name, the automatic file name creation system 100 may transmit information about an expected time required to create the file name of the first file to the user terminal 300, and the user terminal 300 may display information about the expected time thereon.

When the file name is created using the first artificial neural network and the second artificial neural network, a considerable amount of time is required. In this case, when the user does not store the file and ends an editing application of the file being created, an event in which contents of the file on which the user works is lost may occur. According to the present embodiment, preemptively storing the contents of the file using a temporary file name before the file name is created may allow an effect of allowing the user to perform another task for a time duration for which the file name is created to be achieved.

In step S600, the automatic file name creation system 100 may change the file name of the first file to the first file name acquired in step S500.

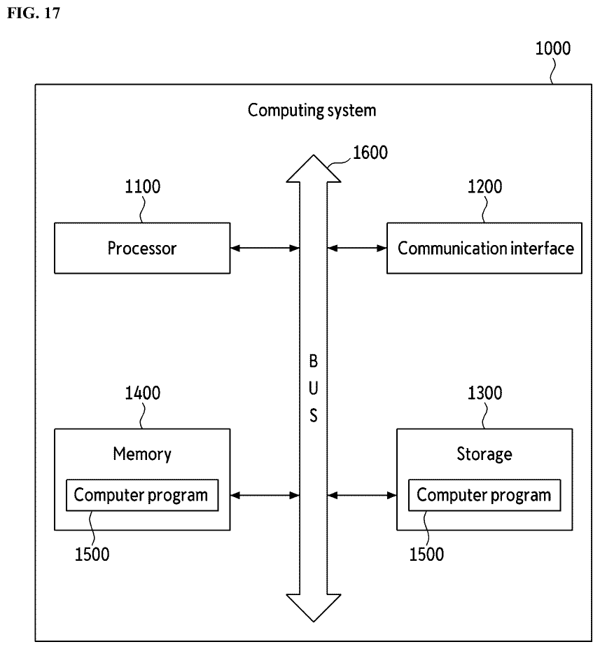

FIG. 17 is a hardware configuration view of an exemplary computing system 1000. Referring to FIG. 17, the computing system 1000 may include at least one processor 1100, a system bus 1600, a communication interface 1200, a memory 1400, which loads a computer program 1500 executed by the processor 1100, and a storage 1300, which stores the computer program 1500.

The processor 1100 may control the overall operations of the components of the computing system 1000. The processor 1100 may perform computations for at least one application or program for executing operations/methods according to some embodiments of the present disclosure. The memory 1400 may store various data, commands, and/or information. The memory 1400 may load the computer program 1500 from the storage 1300 to execute the operations/methods according to some embodiments of the present disclosure. The memory 1400 may be implemented as a volatile memory such as a random access memory (RAM), but the present disclosure is not limited thereto. The bus 1600 may provide communication functionally among the components of the computing system 1000. The communication interface 1200 may support both wired and wireless Internet communication for the computing system 1000. The storage may temporarily store at least one computer program 1500. The computer program 1500 may include one or more instructions that, upon being loaded into the memory 1400, direct the processor 1100 to perform the operations/methods according to some embodiments of the present disclosure. In other words, by executing the loaded instructions, the processor 1100 may perform the operations/methods according to some embodiments of the present disclosure.

In some embodiments, referring to FIG. 17, the computing system 1000 may be a computing system in the automatic file name creation system 100 of FIG. 1. the computing system 1000 may refer to a virtual machine implemented based on cloud technology. For example, the computing system 1000 may be a virtual machine operating on one or more physical servers within a server farm. In this example, at least some of the components of the computing system 1000, i.e., the processor 1100, the memory 1400, and the storage 1300, may be implemented as virtual hardware, and the communication interface 1200 may be implemented as a virtual networking element such as a virtual switch.

A computer program 1500 according to an embodiment of the disclosure may include instructions for: acquiring a first file as a file name change target; receiving first setting information about one of semantic information represented by contents of the first file; creating a first prompt instructing to extract first semantic information from the first file based on the first setting information; inputting the first file and the first prompt to a first artificial neural network, and creating a first semantic text corresponding to the first semantic information of the first file based on an output of the first artificial neural network; receiving second setting information specifying a file name creation rule; creating a second prompt instructing to modify the first semantic text according to the file name creation rule based on the second setting information; inputting the first semantic text and the second prompt to a second artificial neural network, and creating a first file name associated with the first semantic text corresponding to the file name creation rule, based on an output of the second artificial neural network; and changing the file name of the first file to the first file name.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive but illustrative in all respects.

What is claimed is:

1. An automatic file name creation method performed by a computing system, the method comprising:
acquiring a first file as a file name change target;
receiving first setting information about one of semantic information represented by contents of the first file;
creating a first prompt instructing to extract first semantic information from the first file based on the first setting information;
inputting the first file and the first prompt to a first artificial neural network, and creating a first semantic text corresponding to the first semantic information of the first file based on an output of the first artificial neural network;
receiving second setting information specifying a file name creation rule;
creating a second prompt instructing to modify the first semantic text according to the file name creation rule based on the second setting information;
inputting the first semantic text and the second prompt to a second artificial neural network, and creating a first file name associated with the first semantic text corresponding to the file name creation rule, based on an output of the second artificial neural network; and
changing a file name of the first file to the first file name,
wherein the first artificial neural network is a large multi-modal model,
wherein the second artificial neural network is a large language model.

2. The automatic file name creation method of claim 1, further comprising:
identifying that a user uploads the first file in a first chatting session via a message application; and
inputting a context of the first chatting session and the first file to the first artificial neural network, and creating the first semantic text corresponding to the context of the first chatting session, based on the output of the first artificial neural network.

3. The automatic file name creation method of claim 1, wherein when the first file has an image format, the first semantic information is information related to a first object included in an image of the first file,
wherein the creating of the first semantic text corresponding to the first semantic information includes:
inputting the first file and the first prompt to the first artificial neural network; and
creating the first semantic text associated with the first object, based on the output of the first artificial neural network.

4. The automatic file name creation method of claim 1, wherein when the first file has a video format, the first semantic information is information related to a motion of an object included in a video of the first file.

5. The automatic file name creation method of claim 1, wherein when the first file has an audio format, the first semantic information is information related to a script of an utterance included in an audio of the first file.

6. The automatic file name creation method of claim 1, wherein the acquiring of the first file as the file name change target includes:
determining, as the file name change target, the first file corresponding to third setting information among an acquired plurality of files, based on the third setting information input by a user.

7. The automatic file name creation method of claim 6, wherein the determining of the first file corresponding to the third setting information among the acquired plurality of files as the file name change target, based on the third setting information input by the user includes:
determining, as the file name change target, the first file including a first object specified by the third setting information among an acquired plurality of image format files.

8. The automatic file name creation method of claim 6, wherein the determining of the first file corresponding to the third setting information among the acquired plurality of files as the file name change target, based on the third setting information input by the user includes:
determining, as the file name change target, the first file including an object performing a first motion specified by the third setting information among an acquired plurality of video format files.

9. The automatic file name creation method of claim 6, wherein the determining of the first file corresponding to the third setting information among the acquired plurality of files as the file name change target, based on the third setting information input by the user includes:
determining, as the file name change target, the first file including utterance of a first speaker specified by the third setting information among an acquired plurality of audio format files.

10. The automatic file name creation method of claim 1, wherein the second prompt is determined based on a file name format of a file having a history in which a user has manually changed a file name, and
wherein the file having the history in which the user has manually changed the file name is a file having a similarity to the first file greater than or equal to a reference value.

11. The automatic file name creation method of claim 1, further comprising:
receiving, from a user, a request to store the first file being created by the user;
storing the first file using a temporary file name; and
displaying information about a time required to create the file name of the first file on a screen.

12. An automatic file name creation system comprising:
one or more processors; and
a memory storing therein a computer program executed by the one or more processors,
wherein the computer program includes instructions for:
acquiring a first file as a file name change target;
receiving first setting information about one of semantic information represented by contents of the first file;
creating a first prompt instructing to extract first semantic information from the first file based on the first setting information;
inputting the first file and the first prompt to a first artificial neural network, and creating a first semantic text corresponding to the first semantic information of the first file based on an output of the first artificial neural network;
receiving second setting information specifying a file name creation rule;
creating a second prompt instructing to modify the first semantic text according to the file name creation rule based on the second setting information;
inputting the first semantic text and the second prompt to a second artificial neural network, and creating a first file name associated with the first semantic text corresponding to the file name creation rule, based on an output of the second artificial neural network; and
changing a file name of the first file to the first file name,
wherein the first artificial neural network is a large multi-modal model,
wherein the second artificial neural network is a large language model.

13. The automatic file name creation system of claim 12, wherein when the first file has an image format, the first semantic information is information related to a first object included in an image of the first file,
wherein the creating of the first semantic text corresponding to the first semantic information includes:
inputting the first file and the first prompt to the first artificial neural network; and
creating the first semantic text associated with the first object, based on the output of the first artificial neural network.

14. The automatic file name creation system of claim 12, wherein when the first file has a video format, the first semantic information is information related to a motion of an object included in a video of the first file.

15. The automatic file name creation system of claim 12, wherein when the first file has an audio format, the first semantic information is information related to a script of an utterance included in an audio of the first file.

16. The automatic file name creation system of claim 12, wherein the acquiring of the first file as the file name change target includes:
determining, as the file name change target, the first file corresponding to third setting information among an acquired plurality of files, based on the third setting information input by a user.

17. The automatic file name creation system of claim 16, wherein the determining of the first file corresponding to the third setting information among the acquired plurality of files as the file name change target, based on the third setting information input by the user includes:
determining, as the file name change target, the first file including a first object specified by the third setting information among an acquired plurality of image format files.

18. The automatic file name creation system of claim 16, wherein the determining of the first file corresponding to the third setting information among the acquired plurality of files as the file name change target, based on the third setting information input by the user includes:
determining, as the file name change target, the first file including an object performing a first motion specified by the third setting information among an acquired plurality of video format files.

19. The automatic file name creation system of claim 16, wherein the determining of the first file corresponding to the third setting information among the acquired plurality of files as the file name change target, based on the third setting information input by the user includes:
determining, as the file name change target, the first file including utterance of a first speaker specified by the third setting information among an acquired plurality of audio format files.

20. The automatic file name creation system of claim 12, wherein the computer program further includes instructions for:
identifying that a user uploads the first file in a first chatting session via a message application; and
inputting a context of the first chatting session and the first file to the first artificial neural network, and creating the first semantic text corresponding to the context of the first chatting session, based on an output of the first artificial neural network.
